(19) United States
(12) Patent Application Publication
(10) Pub. No.: US 2012/0227939 A1
(43) Pub. Date: Sep. 13, 2012

(54) Turbulence insert for flat heat exchanger pipes, flat pipe for a heat exchanger having such a turbulence insert, heat exchager having such flat pipes, as well as method and device for the production ofsuch a flat pipe

(75) Inventor: Norbert Aplienz, Duelmen (DE)

(73) Assignee: ARUP Alu-Rohr und Profil GmbH, Dortmund (DE)

(21) Appl. No.: 13/065,772

(22) Filed: Mar. 30, 2011

(30) Foreign Application Priority Data
Mar. 7, 2011 (DE) 10 2011 013 244.9

(51) Int. Cl. F28F 13/12; B23P 15/26

(52) U.S. Cl. 165/109.1; 29/890.053

(57) ABSTRACT

The present invention relates to a turbulence insert (21) for flat pipes (4) for heat exchangers, to a flat pipe (4) for heat exchangers, particularly for pipes in mobile and stationary liquefiers, evaporators, and heating system, having such an internal turbulence insert (21), as well as to a heat exchanger having such flat pipes (4), as well as to a method as well as a device for the production of such a flat pipe (4).

The present invention relates to a turbulence insert for flat pipes for heat exchangers, to a flat pipe for heat exchangers, particularly for pipes in mobile and stationary liquefiers, evaporators, and heating system, having such an internal turbulence insert, as well as to a heat exchanger having such flat pipes. Furthermore, the present invention relates to a method as well as a device for the production of such a flat pipe.

Flat pipes of the type indicated usually serve for connecting an inlet collection container with an outlet collection container of a heat exchanger, for example a liquefier or an evaporator, in terms of flow technology, for which purpose the flat pipes are stacked one on top of the other and disposed adjacent to one another with their broad pipe sides, and open into the inlet or outlet collection container, in each instance, with their pipe ends. Furthermore, metal sheets in the manner of lamellae or corrugations are preferably disposed between the flat pipes, which sheets are soldered onto the broad sides of the flat pipes with their peaks. The metal sheets serve to increase the heat exchanger surface area. A liquid and/or gaseous medium flows through the flat pipes, and a gaseous medium generally flows between and through the metal sheets, whereby a heat exchange takes place between the two media.

In order to improve the heat transfer, it is known that the flat pipes have internal metal turbulence sheets or turbulence inserts. These primarily serve to produce a turbulent flow as well as to increase the heat transfer surface area of the medium that flows through the flat pipes. Furthermore, the turbulence inserts can be soldered to the pipe wall of the flat pipes, so that they also serve to increase the internal pressure resistance on the basis of a tie rod effect.

The turbulence inserts are, for example, corrugated metal sheets (“wave fins”), which are produced by means of roll molding, for example, and form multiple flow chambers that lie adjacent to one another and extend continuously in one longitudinal pipe direction, in each instance. Alternatively to this, the turbulence inserts are so-called offset fins, which form flow chambers, in each instance, which are disposed one behind the other in the longitudinal pipe direction, whereby the flow chambers that are disposed one behind the other are disposed offset relative to one another in a transverse pipe direction. As a result, edges disposed offset relative to one another are formed, which the flow impacts, thereby producing turbulence. A possible embodiment of offset fins is known from DE 10 2006 031 675 A1, for example.

A turbulence insert for flat pipes is known from DE 39 15 208 A1, which consists essentially of a flat strip, and, viewed in the longitudinal direction of the strip, has deformations on both sides of the strip plane, whereby wave shapes extend along the strip edge, on each side, next to a center axis of the strip, which shapes are disposed offset relative to one another with reference to the longitudinal direction of the strip. Furthermore, the turbulence insert according to DE 39 15 208 A1 can have embossed beads and/or hemispherical embossings along the center axis, alternating on both sides of the normal plane.

A flat heat exchanger pipe having an inner insert as well as having two flat sides and two broad sides is evident from DE 10 2006 033 570 A1, whereby the inner insert is configured and disposed in such a manner that the medium that flows in the pipe must move in spiral shape in the longitudinal direction of the pipe. For this purpose, the inner insert can have shaped parts that face toward the two broad sides, the placement directions of which shaped parts intersect. The shaped parts can be tabs or rectangular projections. For production reasons, the face sides of the rectangular projections must be open.

For the production of flat pipes having an internal turbulence insert, usually the pre-finished turbulence inserts are pushed into the pre-finished flat pipes, and it is practical if they are soldered together. This production method is relatively complicated. In particular, this is a multi-stage process in which the flat pipes have to be picked up by hand multiple times, which brings high costs with it.

Furthermore, it is known, for example from DE 10 2006 031 675 A1, to produce the flat pipes, together with the turbulence inserts, from one piece. For this purpose, a section of a flat strip is first formed into an endless turbulence insert, step by step, by means of roll molding, among other methods, whereby the flat strip is left smooth to the side, next to the formed section. Subsequently, the smooth sections are bent and wound around the formed section, so that an endless flat pipe is formed. The endless flat pipe is subsequently welded on the longitudinal side and cut to length.

Furthermore, a method for the continuous production of flat pipes with an internal turbulence insert is known from DE 10 2009 053 579 A1, in which method a first metallic endless flat strip material and a second endless flat strip material are made available, and brought together in such a manner that these lie against one another with their broad sides. Before they are brought together, the first endless flat strip material is formed into an endless profile sheet, particularly by means of two embossing rollers that can be rotated in opposite directions of rotation, between which rollers the first endless flat strip material is passed. The second endless flat strip material and the profiled endless profile sheet, after they have been brought together, are continuously bent, by means of roll molding, to form an endless flat pipe having a longitudinally slit pipe wall with two longitudinal pipe wall edges that lie opposite one another, and a longitudinally slit endless turbulence insert, whereby the pipe wall encloses the endless turbulence insert. The two longitudinal pipe wall edges are subsequently welded to one another and afterwards, the endless flat pipe is cut to length, into individual flat pipes, in a cutting device.

It is the task of the invention to make available a turbulence insert for flat heat exchanger pipes, which insert guarantees good heat exchange properties of the flat pipes at the lowest possible pressure loss. Furthermore, the turbulence insert is supposed to bring about great stability of the flat pipes with regard to pressure stress from the outside and the inside.

Further tasks of the invention are making available a flat pipe having such a turbulence insert, and a heat exchanger having such flat pipes, as well as a device and a method for simple, fast, and cost-advantageous production of such a flat pipe.

These tasks are accomplished by means of a turbulence insert having the characteristics of claim 1, a flat pipe having the characteristics of claim 7, a heat exchanger having the characteristics of claim 12, as well as a method and a device having the characteristics of claims 13 and 14.

In the following, the invention will be described in greater detail using a drawing as an example. This shows:

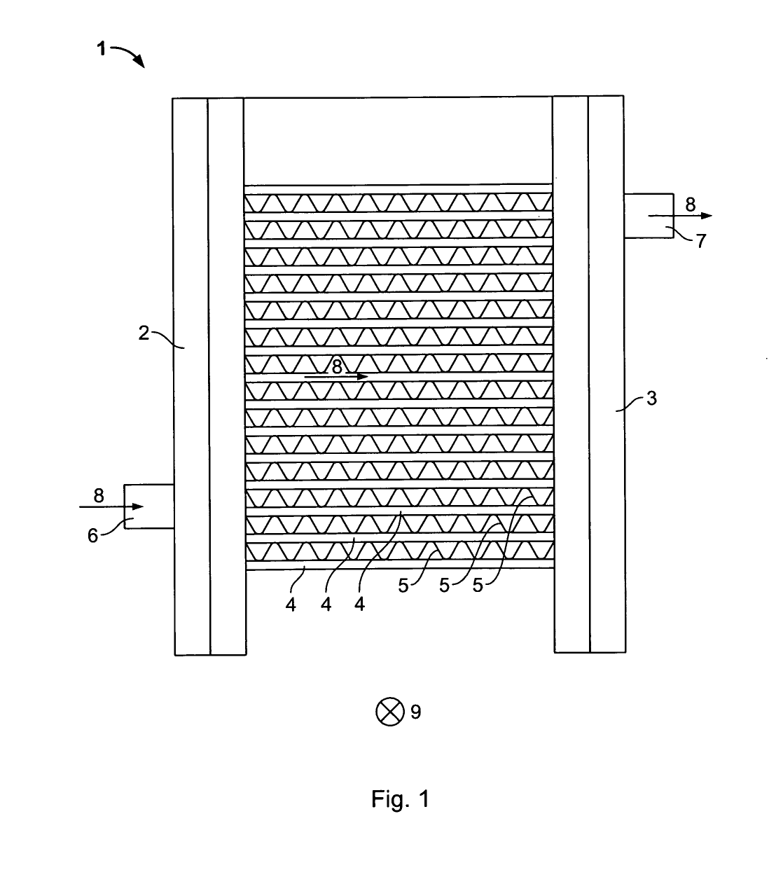

FIG. 1: A schematic view, from the narrow pipe side, of the heat exchanger according to the invention

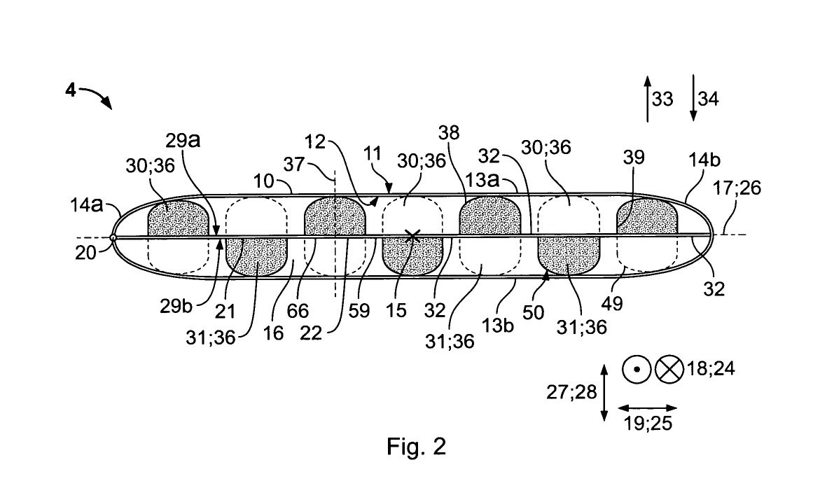

FIG. 2: A schematic face-side view of the flat pipe according to the invention, according to a first embodiment of the invention

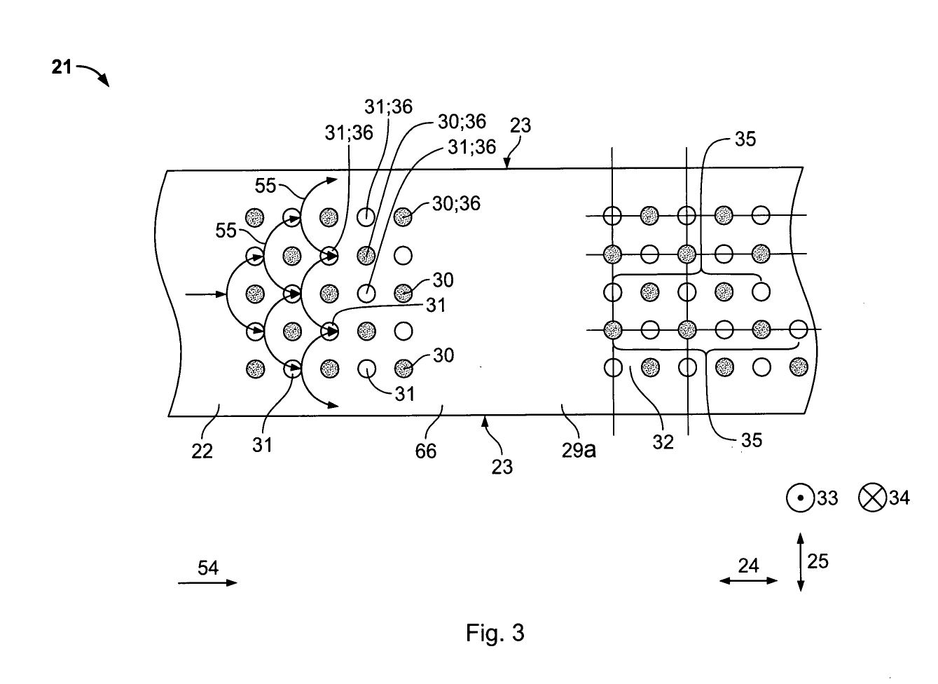

FIG. 3: A schematic top view of the turbulence insert according to the invention, according to a first embodiment of the invention

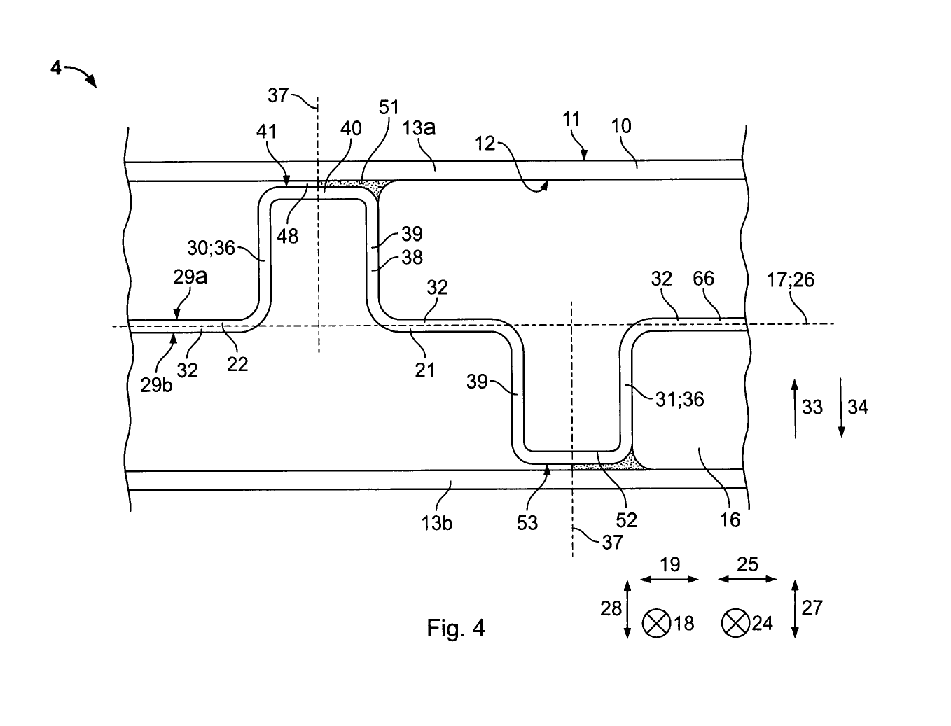

FIG. 4: A schematic detail of a pipe cross-section perpendicular to a longitudinal pipe axis, with further embodiments of the projections

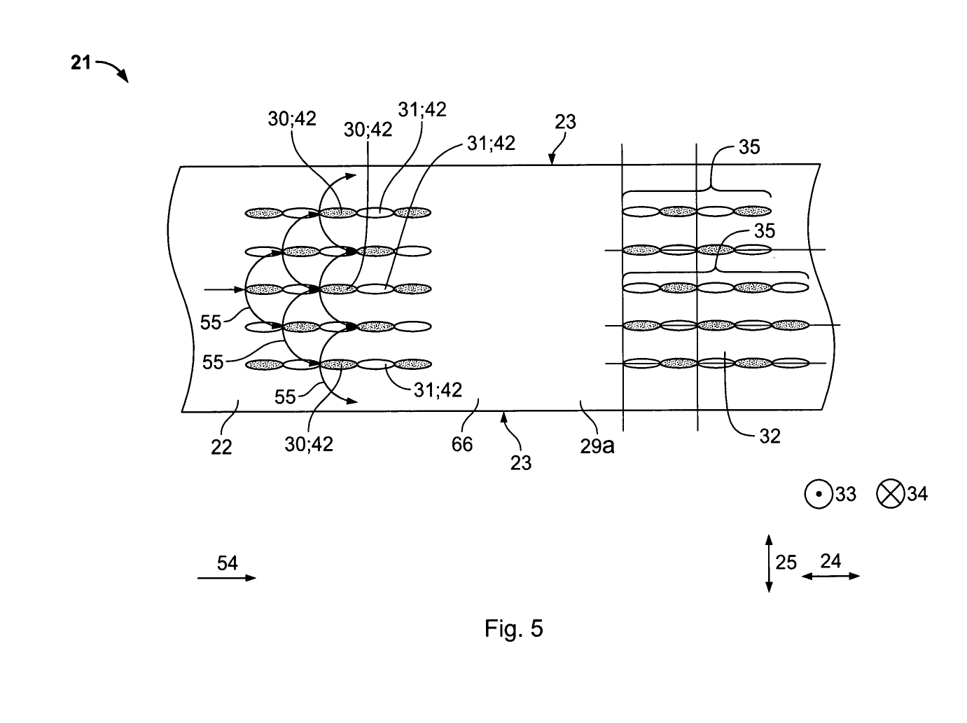

FIG. 5: A schematic top view of the turbulence insert according to the invention, according to a further embodiment of the invention

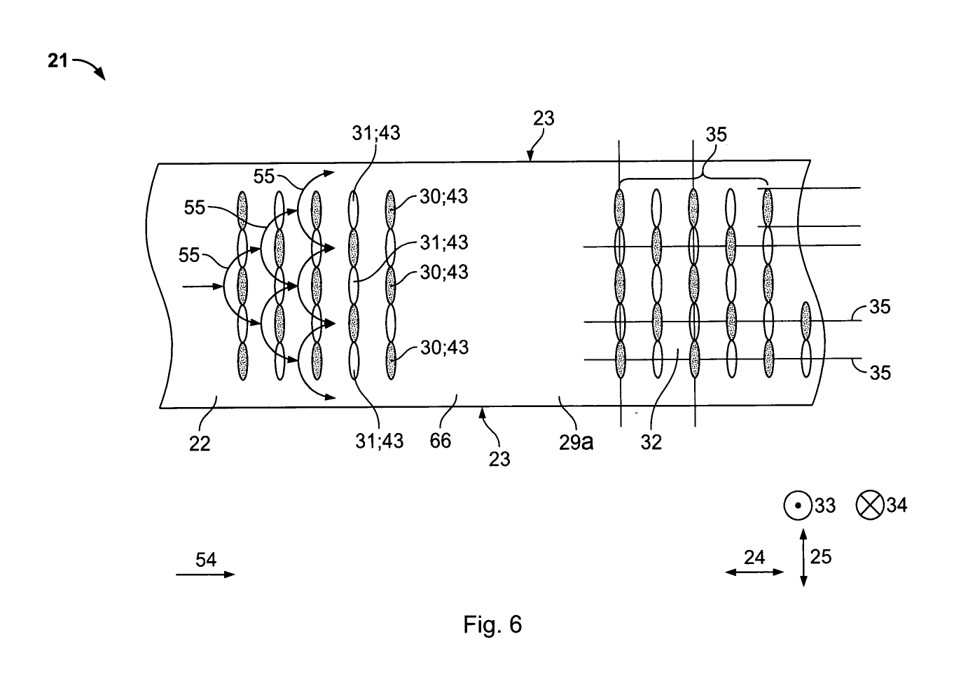

FIG. 6: A schematic top view of the turbulence insert according to the invention, according to a further embodiment of the invention

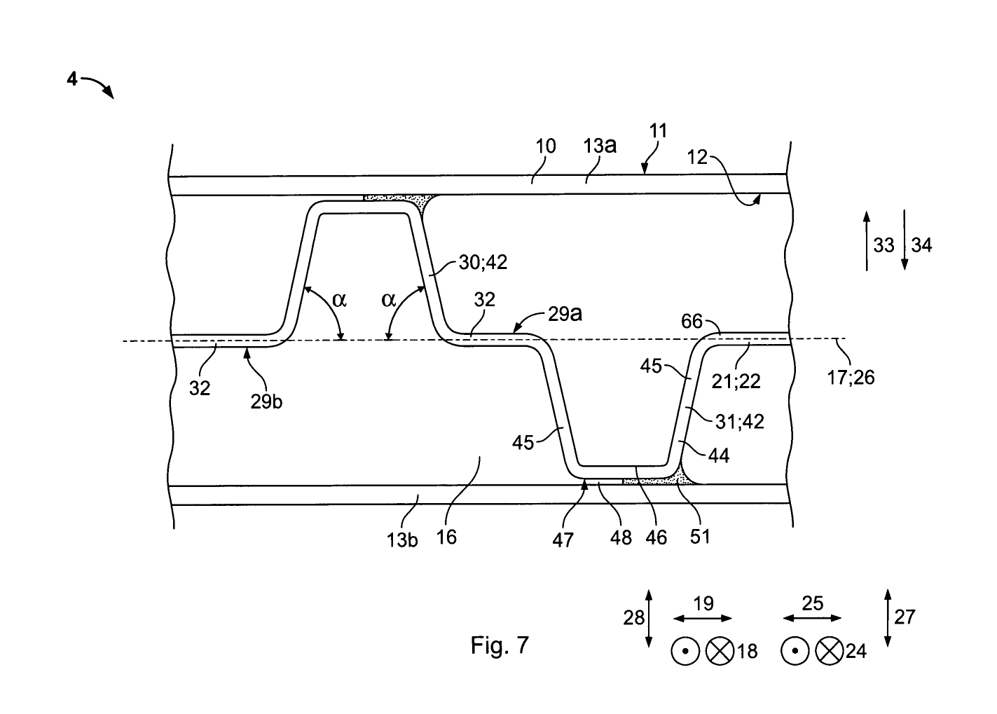

FIG. 7: A schematic detail of a pipe cross-section perpendicular to a longitudinal pipe axis, with a turbulence insert according to FIG. 5

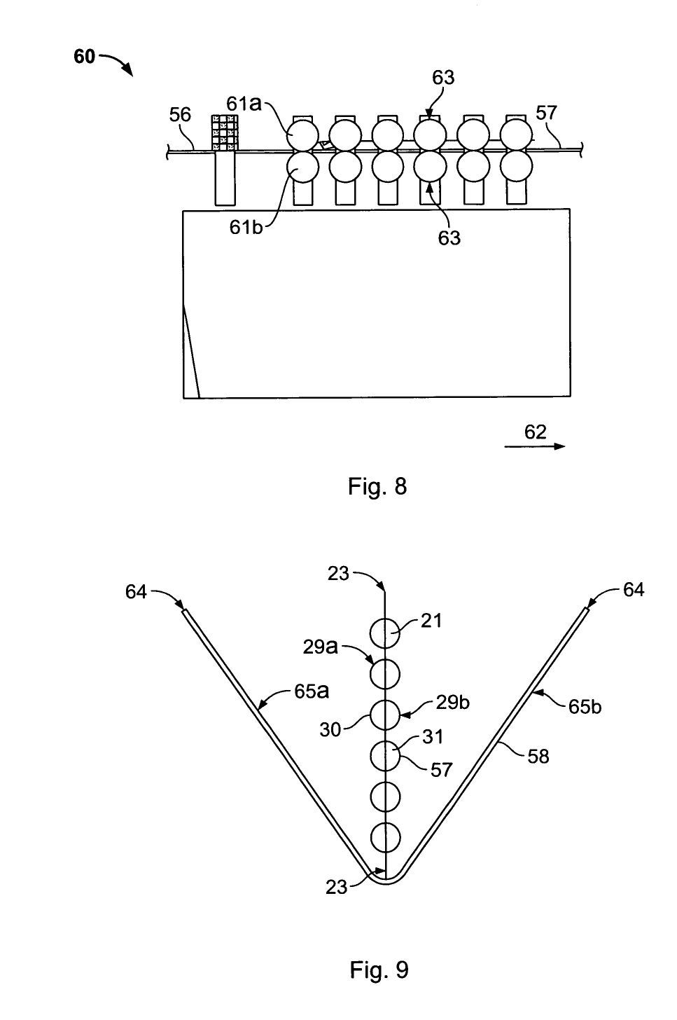

FIG. 8: Schematically, a side view of a forming device of the devices according to the invention

FIG. 9: Schematically, a cross-section of a second endless flat strip material and an endless turbulence insert according to the invention, after having been brought together, the second endless flat strip material partly bent

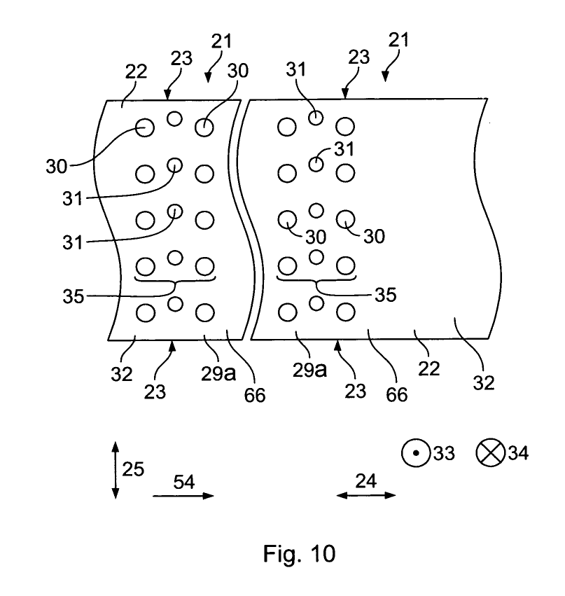

FIG. 10: A schematic top view of the turbulence insert according to the invention, according to two further embodiments of the invention

The heat exchanger 1 according to the invention (FIG. 1) has an inlet collection container 2, an outlet collection container 3 disposed at a distance from the former, multiple flat pipes 4 according to the invention disposed parallel to one another and next to one another, as well as spaced apart from one another, as well as lamella-type or corrugated-type metal sheets 5, preferably disposed between the flat pipes 4 and standing in connection with them, which sheets serve to increase the heat exchange surface. Preferably, the heat exchanger 1 is a mobile or stationary condenser (liquefier) or a mobile or stationary evaporator or a mobile or stationary heating system. In particular, the flat pipes 4 of the heat exchanger 1 are under very high interior pressures of up to 15 bar. In this connection, the flat pipes 4 are disposed between the two collection containers 2, 3 and connect them with one another, in terms of flow. The inlet collection container 2 has an inlet opening to allow the cooling first medium to enter into the inlet collection container 2. The outlet collection container 3 has an outlet opening to allow the cooled first medium to exit from the outlet container 3. In this connection, the inlet opening is preferably followed by an inlet connector piece 6 for a connection to the cooling or heating system, and the outlet opening is followed by an outlet connector piece 7 for a connection to the cooling or heating system. The heat exchanger 1 according to the invention is therefore a counter-current heat exchanger, in which a first liquid or gaseous medium that is to be cooled or that gives off heat flows from the inlet collection container 2, in a flow direction 8, through the flat pipes 4, into the outlet collection container 3, and is cooled while doing so. Cooling takes place by means of heat exchange with a second medium that cools or absorbs heat, typically has a gaseous state, and flows in a counter-current direction 9 between the flat pipes 4, around the lamella-type metal sheets 5, perpendicular to the flow direction 8, and absorbs heat while doing so.

A flat pipe 4 according to the invention (FIGS. 2, 4, 7) has a pipe wall 10, in each instance, having an outer pipe wall surface 11 and an inner pipe wall surface 12, as well as two broad pipe side walls 13a; 13b that lie opposite one another and parallel to one another, and two narrow pipe side walls 14a; 14b that lie opposite one another and parallel to one another, by way of which the broad pipe side walls 13a; 13b make a transition into one another. The two broad pipe side walls 13a; 13b are preferably configured to be flat-surfaced or flat or plate shape. The two narrow pipe side walls 14a; 14b are preferably configured to be rounded off or half-round, so that the flat pipe 4 has an essentially flat oval cross-section. However, the narrow pipe side walls 14a; 14b can also be configured to have a flat surface or be flat or in plate shape, so that the flat pipe 4 has an essentially rectangular cross-section.

The pipe wall 10 furthermore delimits a pipe interior that forms a flow channel 16 of the flat pipe 4 that extends parallel to a central longitudinal pipe axis 15. Furthermore, the flat pipe 4 according to the invention has a pipe center plane 17 that contains the longitudinal pipe axis 15 and is disposed centered between the two broad pipe side walls 13a; 13b and parallel to them. Furthermore, the flat pipe 4 has a longitudinal pipe direction 18 that runs parallel to the longitudinal pipe axis 15, and a pipe width direction 19 that runs perpendicular to the longitudinal pipe direction 18 and parallel to the pipe center plane 17. Furthermore, the flat pipe 4 has a pipe height direction 28 that runs perpendicular to the pipe center plane 17.

Preferably, the pipe wall 10 is produced by means of roll forming and closed off on the longitudinal side, particularly by means of a longitudinal weld seam 20 that extends parallel to the longitudinal pipe direction 18, something that will be discussed in greater detail below. It is practical if the longitudinal weld seam 20 is disposed on a first narrow side wall 14a of the two narrow side walls 14a; 14b and centered with reference to that wall, and extends parallel to the longitudinal pipe axis 15. Longitudinal pipe wall edges or pipe wall abutment edges of the pipe wall 10 that lie adjacent to one another or abut one another are welded to one another by means of the longitudinal weld seam 20. However, the longitudinal pipe wall edges that lie adjacent to one another can also be connected with one another in a different way, for example glued or soldered to one another.

The flat pipe 4 according to the invention furthermore has the internal stabilization insert or turbulence insert 21 according to the invention, disposed in the flow channel 16. The turbulence insert 21 is usually also referred to as a turbulator or as a fin.

The turbulence insert 21 according to the invention (FIGS. 2-7) is a single-layer metallic strip or sheet-metal strip 22 having a sheet wall 66, two longitudinal sheet edges or longitudinal strip edges 23 that lie opposite one another, and two sheet face edges or strip face edges 59 that lie opposite one another (FIG. 2). The longitudinal strip edges 23 and preferably also the strip face edges 59 have a linear or straight-line progression, in each instance. In particular, the longitudinal strip edges 23 extend parallel to a longitudinal strip direction 24 that in turn runs parallel to the longitudinal pipe direction 18. The strip face edges 59 preferably extend perpendicular to the longitudinal strip edges 23 and parallel to a strip width direction 25 that runs parallel to the pipe width direction 19. Furthermore, the sheet-metal strip 22 has a sheet center plane or strip center plane 26 that is coplanar to the pipe center plane 17. Furthermore, the sheet-metal strip 22 has a strip thickness direction 27 that runs perpendicular to the strip center plane 26. Furthermore, the sheet-metal strip 22 has two sheet or strip surfaces 29a; 29b that lie opposite one another in the strip thickness direction 27.

The turbulence insert 21 is disposed, particularly centered, between the two broad pipe side walls 13a; 13b. In this connection, a first strip surface 29a is disposed facing the first broad pipe side wall 13a and a second strip surface 29b is disposed facing the second broad pipe side wall 13b.

According to the invention, the turbulence insert 21 or the sheet-metal strip 22 furthermore has multiple first and second elevations or projections 30; 31, in each instance, which are formed into the sheet-metal strip 22, particularly the sheet wall 66, or formed out of or pressed out of or deep-drawn out of the sheet-metal strip 22, particularly the sheet wall 66. The sheet-metal strip 22, particularly the sheet wall 66, consequently has a flat-surfaced or plate-shaped, continuous strip region or sheet wall region 32 that is infiltrated or interrupted by the first and second projections 30; 31. The sheet-metal strip 22, particularly the sheet wall 66, is therefore configured to be flat or plate-shaped, except for the first and second projections 30; 31. In this connection, the plate-shaped strip region 32 is disposed parallel to the two broad pipe side walls 13a, 13b or parallel to the strip center plane 26 and to the pipe center plane 17. Seen in a top view, preferably 70 to 95% of the total surface area of the sheet-metal strip 22 is configured to be flat-surfaced or configured by the flat strip region 32.

In this connection, the first projections 30 are disposed on a first side of the strip center plane 26, and the second projections 31 are disposed on a second side of the strip center plane 26, which side lies opposite the first side. The first and second projections 30; 31 project beyond the plate-shaped strip region 32, viewed in the strip thickness direction 27. The first projections 30 particularly project beyond the plate-shaped strip region 32 in a first direction 33, parallel to the strip thickness direction 27, and the second projections 31 particularly project beyond the plate-shaped strip region 32 in a second direction 34, parallel to the strip thickness direction 27, and opposite the first direction 33. The first projections 30 particularly face toward the first broad pipe side wall 13a and lie against it or support themselves on it, and the second projections 31 particularly face toward the second broad pipe side wall 13b and lie against it or support themselves on it.

Furthermore, the first projections 30 lie against the first broad pipe side wall 13a on the inside, or on the inner pipe surface 12, in the region of the first broad pipe side wall 13a, and are particularly soldered to it. And the second projections 31 lie against the second broad pipe side wall 13b on the inside, or on the inner pipe surface 12, in the region of the second broad pipe side wall 13b, and are particularly soldered to it. As a result, the turbulence insert 21 alternately supports itself on the two broad pipe side walls 13a; 13b.

The first and second projections 30; 31 are disposed, according to the invention, viewed in the longitudinal strip direction 24, one behind the other and alternating, in each instance. Furthermore, the first and second projections 30; 31 are also disposed, viewed in the strip width direction 25, preferably one behind the other and alternating, in each instance. In a top view (FIGS. 3-5), in other words viewed in a view perpendicular to the strip center plane 26, the first and second projections 30; 31, disposed one behind the other in the longitudinal strip direction 24, are preferably disposed aligned with one another, viewed in the longitudinal strip direction 24. Furthermore, in the top view, the first and second projections 30; 31, disposed one behind the other in the strip width direction 25, viewed in the strip width direction 25, are preferably also disposed aligned with one another.

The first and second projections 30; 31 are therefore disposed in the form of multiple longitudinal rows 35 that are disposed adjacent to one another in the strip width direction 25. In other words, the first and second projections 30; 31 form multiple longitudinal rows 35 that are disposed adjacent to one another in the strip width direction 25. In this connection, the first and second projections 30; 31 of a longitudinal row 35 can also be slightly offset, relative to one another, in the strip width direction 25 (FIG. 10). In this case, the first and second projections 30; 31 that are disposed one behind the other in the longitudinal strip direction 24 are disposed aligned with one another in certain regions, in the longitudinal strip direction 24. This means that the first and second projections 30; 31 of a longitudinal row 35 have a width expanse in the strip width direction 25, in each instance, whereby the width expanses are dimensioned in such a manner that there is no gap between the first and second projections 30; 31 of a longitudinal row 55 in the longitudinal strip direction 24. In other words, the width expanses of all the first and second projections 30; 31 of a longitudinal row 35 are aligned, in a top view, in the longitudinal strip direction 24, at least in certain sections. In particular, all the first and second projections 30; 31 of a longitudinal row 35 are disposed in such a manner that they are intersected, viewed in a top view, by a line that extends parallel to the longitudinal strip direction 24, in other words lie on one line.

The longitudinal rows 35 extend parallel to the longitudinal strip direction 24 and particularly over the entire length of the flat pipe 4. In this connection, a longitudinal row 35 has multiple first and multiple second projections 30; 31, which are disposed one behind the other and alternating, in each instance, viewed in the longitudinal strip direction 24. In this connection, the first projections 30 of a longitudinal row 35 are disposed aligned with one another, viewed in the longitudinal strip direction 24, and the second projections 31 of a longitudinal row 35 are also disposed aligned with one another, viewed in the longitudinal strip direction 24. In this connection, the turbulence insert 21 according to the invention has at least two, preferably 4 to 20 longitudinal rows 35 that are disposed adjacent to one another in the strip width direction 25.

In this connection, the longitudinal rows 35 are preferably disposed in such a manner that a first projection 30 of the one longitudinal row 35, viewed in the strip width direction 25, lies adjacent to a second projection 31 of the adjacent longitudinal row 25. In particular, the first projections 30 of the longitudinal rows 35, viewed in the transverse strip direction 25, are disposed aligned with one another, and the second projections 31 of the longitudinal rows 35 are also disposed aligned with one another, viewed in the transverse strip direction 25.

According to a first embodiment of the invention (FIGS. 2-4), the projections 30; 31 are bowl-type or nub-type or pot-shaped projections 36, so-called “dimples.” The bowl-type projections 36 have a projection axis 37, in each instance, that runs perpendicular to the sheet center plane 26. Preferably, the bowl-type projections 36 are configured with rotation symmetry relative to their projection axis 37, in each instance. Furthermore, the bowl-type projections 36 have a bowl wall 38. The bowl wall 38 is part of the sheet wall 66 or is formed by it.

According to one embodiment (FIG. 2), the bowl wall 38, viewed from the sheet center plane 26, has a wall section 39 in the form of a hollow cylinder, at first. The hollow-cylinder wall section 39 is followed by a ceiling wall 49 in the manner of a flattened dome. The ceiling wall 49 has an external outer surface 50 directed away from the sheet center plane 26, rounded or curved in convex manner, with which the projections 36 lie against and support themselves on the broad pipe side wall 13a; 13b, in each instance. It is practical if the projections 36 are soldered to the broad pipe side wall 13a; 13b, in each instance. For this purpose, solder 51 is present between the outer surface 50 and the inner pipe surface 12.

Preferably, the turbulence insert 21 is solder-plated on its two strip surfaces 29a; 29b. Alternatively to this or in addition, the pipe wall 10 is solder-plated on the inner pipe surface 12 and/or on the outer pipe surface 11.

According to an alternative embodiment of the bowl-type projections 36 (FIG. 4, left projection 36), the bowl wall 38 has a plate-shaped or flat ceiling wall 40 instead of the ceiling wall 49 in the shape of a flattened dome. The ceiling wall 40 extends parallel to the sheet center plane 26 and is particularly spaced apart from the latter. Furthermore, the ceiling wall 40 has an external, flat-surfaced outer surface 41, directed away from the sheet center plane 26, which lies against the broad pipe side wall 13a; 13b, in each instance, or is preferably spaced apart from the broad pipe side wall 13a; 13b, in each instance, by a defined solder gap 48. In this case, the projections 36 are soldered to the broad pipe side wall 13a; 13b, in each instance. For this purpose, once again solder 51 is present between the outer surface 41 and the inner pipe surface 12.

According to another alternative embodiment of the bowl-like projections 36 (FIG. 4, right projection 36), the bowl wall 38 has a ceiling wall 52 that has an outer surface 53 that narrows conically, viewed from the sheet center plane 26, where it is practical that the projections 36 lie against and support themselves on the broad pipe side wall 13a; 13b, in each instance, with this surface. Once again, it is practical if solder 51 is present between the outer surface 53 and the inner pipe surface 12.

According to another embodiment of the invention (FIG. 5), the projections 30; 31 are longitudinal beads or longitudinal dimples or bead-shaped projections 42 oriented longitudinally in the longitudinal strip direction 24. The longitudinal beads 42 have a longitudinal expanse in the direction of the longitudinal strip direction 24.

According to another embodiment of the invention (FIG. 6), the projections 30; 31 are transverse beads or transverse dimples or bead-shaped projections 43 oriented longitudinally in the strip width direction 25. The transverse beads 43 have a longitudinal expanse in the direction of the strip width direction 25.

In cross-section, in other words a section perpendicular to their longitudinal expanse, in each instance, the longitudinal beads 42 and the transverse beads 43 have a wave profile, in each instance, particularly a trapezoid profile (FIG. 7) or a triangular profile or a rectangular profile or a sine-type wave profile.

In the case of the trapezoid profile (FIG. 7), the longitudinal beads or dimples 42 and the transverse beads or dimples 43 have a bead wall or dimple wall 44, in each instance, having two, particularly plate-shaped shank walls 45 and a flat or plate-shaped peak wall 46, by way of which the shank walls 45 make a transition into one another. The bead wall 44 is part of the sheet wall 66 or is formed by it. The slanted shank walls 45 enclose an angle α<90° with the sheet center plane 26. The peak walls 46 extend parallel to the sheet center plane 26 and, in particular, at a distance from it. Furthermore, the peak walls 46 have an external, flat-surfaced outer surface 47, in each instance, directed away from the sheet center plane 26, with which surface the beads 42; 43 support themselves on the broad pipe side wall 13a; 13b, in each instance. It is practical if once again, solder 51 is present between the outer surface 47 and the inner pipe surface 12, so that the beads 42; 43 are soldered to the broad pipe side wall 13a; 13b, in each instance.

According to another embodiment (not shown), the peak walls are configured in wedge shape or roof shape, whereby they taper toward the broad side wall 13a; 13b, against which they support themselves, in each instance. In particular, the peak walls have a wedge-shaped outer surface that tapers toward the broad side wall 13a; 13b, in each instance.

In all the embodiments, it is advantageous that the medium that flows through the flat pipe 4, in the main flow direction 54, is forced, because of the arrangement of the first and second projections 30; 31, as described, to flow through the flat pipe 4 in meander shape. The medium flows through the flat pipe 4 along compulsory meander-shaped flow paths 55 (shown schematically in FIG. 3, 5, 6). This is because the projections 30; 31 project into the flow channel 16 and are disposed in the flow path of the medium. When the medium flowing in the main flow direction 54 impacts a projection 30; 31, it bounces off the latter laterally and flows around the projection 30; 31, in each instance. As a result, the entire flow path of the medium is clearly lengthened and the heat transfer output of the flat pipe 4 is significantly improved. Since the walls 38, 44 of the projections 30; 31; 36; 42; 43 are preferably closed, the walls 38, 44 form an external, closed rebound surface on which the medium impacts, and from which the medium bounces back. This guarantees good turbulence of the medium.

Not only the maximal possible internal pressure but also the flow guidance and the extent of the turbulence can be adjusted by means of any desired variation of the distance of the projections 30; 31 relative to one another in the longitudinal strip direction 24 and/or in the transverse strip direction 25. In particular, the wavelength of the medium can be adjusted by way of the distance of the similar projections 30; 31 relative to one another, in each instance, in the longitudinal strip direction 24. And the clear passage can be adjusted by way of the distance of the projections 30; 31 relative to one another in the transverse strip direction 25.

Furthermore, the shape-fit arrangement of the turbulence insert 21 within the pipe wall 10 has the advantage that the turbulence insert 21 supports the pipe wall 10, so that the stability of the flat pipe 4 according to the invention, particularly the pressure resistance in the case of pressure on the broad pipe side walls 13a; 13b, is significantly increased. The turbulence insert 21 therefore supports itself on the two broad pipe side walls 13a; 13b at multiple locations, in the pipe height direction 28.

In particular, it is advantageous that the projections 30; 31; 36; 42; 43 alternately support themselves on the two broad pipe side walls 13a; 13b on the inside, because of their alternate arrangement. In particular, the projections 30; 31; 36; 42; 43 support themselves on the two broad pipe side walls 13a; 13b on the inside, lying against them, with their ceiling walls 40; 49; 52 or their peak walls 46. As a result, the flat pipe 4 according to the invention withstands very great pressures from the outside.

If the projections 30; 31; 36; 42; 43 are soldered to the inner pipe surface 12, particularly with the ceiling walls 40; 49; 52 or their peak walls 46, the flat pipe 4 furthermore withstands very great inside pressures. This is because the turbulence inserts 21 then act as tie rods. The forces that occur are passed on from the one broad pipe side wall 13a; 13b to the one projections 30; 31; 36; 42; 43, and then passed on to the other broad pipe side wall 13a; 13b, by means of the complete turbulence insert 21, with the opposite force direction. This results in forces that cancel one another out.

The wall thickness or wall breadth of the sheet wall 66 of the sheet-metal strip 22 can furthermore be selected to be very low, particularly because the projections 30; 31 bring about reinforcement and strain hardening. In particular, the wall thickness amounts to 0.05 to 0.5 mm. This results in a saving in material. Furthermore, the flow channel 16 is only minimally blocked.

If the two longitudinal strip edges 23 lie against one of the two narrow pipe side walls 14a; 14b on the inside, in each instance, the flat pipe 4 according to the invention is optimally reinforced at the two narrow pipe side walls 14a; 14b. Furthermore, the sheet-metal strip 22 can also be bent and folded in the region of the two narrow pipe side walls 14a; 14b, in such a manner that it lies against the two narrow pipe side walls 14a; 14b with shape fit and thereby reinforces them.

An additional advantage occurs when the heat exchanger 1 is assembled, in that the projections 30; 31 permit a certain spring effect when external pressure acts on the flat pipes 4, so that a desired contact of the contact surfaces required for perfect soldering is supported.

Furthermore, it is advantageous that the pipe wall 10, particularly the outer pipe surface 11, is configured to be smooth. This guarantees good contact and secure soldering of the outer pipe surface 11 with the wave-type metal sheets 5 (cooling lamellae) of the heat exchanger 1. Furthermore, the pipe ends can be soldered to the collection containers 2; 3, without any problems.

In this connection, the individual projections 30; 31 do not have to be identical. The turbulence insert 21 can have both bowl-type projections 36 and beads 42; 43, for example.

In the following, the production method according to the invention, by means of the device according to the invention, will be described in greater detail:

The device according to the invention, for production of the flat pipe 4, has a turbulence insert pre-finishing device having means for making available a first metallic endless flat strip material 56 and having means for the production of a profiled endless turbulence insert 57 from this material, means for making available a second metallic endless flat strip material or a sheathing strip 58, a combining device, multiple bending devices, preferably a welding device, expediently a scraping device, expediently a cooling device, expediently a calibration device, and a cutting device.

The turbulence insert pre-finishing device has a known supply device for the first metallic endless flat strip material 56, a forming device 60, and expediently a flux coating device that follows the forming device 60.

The supply device is a strip storage unit, for example, and has at least one supply roll from which the metallic first endless flat strip material 56, which is expediently solder-plated on one or both sides, is unwound essentially continuously. In this connection, the first endless flat strip material 56 has a wall thickness that corresponds to the wall thickness of the subsequent turbulence insert 21. Furthermore, the first endless flat strip material 56 preferably consists of aluminum and/or copper and/or steel. Furthermore, the first endless flat strip material 56 is preferably solder-plated on both sides. The first endless flat strip material 56 is preferably guided on edge, in other words in such a manner that its two longitudinal strip edges are disposed vertically aligned with one another.

The forming device 60 (FIG. 8) serves for forming the first flat strip material 56 to produce the endless turbulence insert 57 that has the projections 30; 31; 36; 42; 43. It is practical if profiling takes place by means of roll forming. For this purpose, the forming device 60 has multiple pairs of two rolling rollers 61a; 61b that are disposed adjacent to one another in the horizontal direction and mounted so as to rotate, the axes of rotation of which rollers are oriented vertically and perpendicular to a horizontal transport direction 62. The two rolling rollers 61a; 61b can furthermore be driven in opposite directions of rotation, and are disposed spaced apart from one another in such a manner that the first flat strip material 56 is profiled or formed when it is passed through between the two rolling rollers 61a; 61b. In order to introduce the projections 30; 31; 36; 42; 43 into the first flat strip material 56, the two rolling rollers 61a; 61b have embossing surfaces or rolling surfaces 63, which lie on the outside, revolve, are essentially cylindrical, and have the positive or negative embossing shapes, in each instance, of the projections 30; 31; 36; 42; 43 to be introduced into the flat strip material 56. In particular, the two rolling surfaces 63 have not only positive, convex or projecting embossing shapes, but also negative, concave embossing shapes, in other words curved inward, in order to introduce the alternately projecting projections 30; 31; 36; 42; 43. Preferably, the rolling rollers 61a; 61b are formed from multiple disks (not shown), which can be combined with one another as desired, in order to implement the different configurations and arrangements of the projections 30; 31; 36; 42; 43 as described above. For this purpose, the disks have the corresponding embossing shapes on their cylindrical disk circumference surfaces. Furthermore, disks with a smooth circumference surface can also be present, by means of which the distance of the projections 30; 31; 36; 42; 43, relative to one another, can be adjusted in the strip width direction 25.

The endless turbulence insert 57 that is produced is configured in accordance with the subsequent turbulence insert 21 and consequently has the two longitudinal strip edges 23, the two strip surfaces 29a; 29b, and the projections 30; 31; 36; 42; 43. Furthermore, it is practical if the endless turbulence insert 57 is guided on edge, in other words in such a manner that the two longitudinal strip edges 23 are disposed to align with one another in the vertical direction.

The flux coating device that is preferably present, which is expediently disposed following the forming device or shaping device 60, serves for coating the endless turbulence insert 57 with flux, particularly on both sides. For this purpose, the flux coating device has an application device and a drying device or drying segment that follows it, particularly a drying oven. The endless turbulence insert 57 is coated with flux by means of the application device, on both strip surfaces 29a; 29b, over the full area or a partial area, in each instance, for example in the form of longitudinally extending coating strips. In particular, the outer surfaces 41; 47; 50; 53 are coated. In the subsequent drying device, the coating that has been applied is dried, for example at 120-180° C.

Alternatively to this, the flux can also be applied at a different location, for example before forming of the first flat strip material 56. Or a first flat strip material 56 that has already been coated with flux in advance, particularly on both sides, is used.

The device according to the invention has a second supply device for the second endless flat strip material or the sheathing strip 58 as a means for making available the second endless flat strip material 58, for the production of the pipe wall 10 of the flat pipes 4. The second supply device is also a strip storage unit, for example, and has at least one supply roller from which the metallic second endless flat strip material 58, which is expediently solder-plated on one or both sides, is unwound, essentially continuously. In this connection, it is practical if the second endless flat strip material 58 has a wall thickness corresponding to the desired wall thickness of the pipe wall 10 of the flat pipe 4 to be produced, of 0.2 to 2 mm, preferably 0.3 to 1 mm. Furthermore, the second endless flat strip material 58 preferably consists of aluminum and/or copper and/or steel, whereby it does not have to consist of the same material as the first endless flat strip material 56. Furthermore, the second endless flat strip material 58 has two longitudinal strip edges 64 that extend parallel to the horizontal transport direction 62, as well as a first, preferably horizontal, flat-surfaced broad strip side 65a, and a second, preferably horizontal, flat-surfaced broad strip side 65b. The first broad strip side 65a is preferably disposed above the second broad strip side 65b. The guidance of the second endless flat strip material 58 therefore expediently takes place in such a manner that the plate-shaped endless flat strip material 58 is oriented horizontally. Furthermore, the first endless flat strip material 56 or the endless turbulence insert 57 is preferably guided slightly above the second endless flat strip material 58 and laterally next to it.

The combining device serves for bringing together the endless turbulence insert 57 and the second endless flat strip material 58. In the combining device, the endless turbulence insert 57 is guided in such a manner that one of the two longitudinal strip edges 23, preferably the upper one, of the endless turbulence insert 57 lies, particularly centered, against the first, upper broad strip side 65a of the second endless flat strip material 58, particularly centered, and the endless turbulence insert 57 preferably runs perpendicular to the first broad strip side 65a of the second endless flat strip material 58.

Following the combining device in the transport direction 62 are the bending devices for forming an endless flat pipe. The second endless flat strip material 58 is bent around axes parallel to the transport direction 62, by means of the bending devices, in such a manner that the longitudinally slit pipe wall 10 of the flat pipe 4 to be produced is formed. In particular, the pipe wall 10 consequently has the two broad pipe side walls 13a; 13b, and the two narrow pipe side walls 14a; 14b, and expediently a flat oval or rectangular cross-section. For this purpose, the second endless flat strip material 58 is bent around bending axes that run parallel to the transport direction 62, in such a manner that the two longitudinal pipe edges 64 abut one another and form two longitudinal pipe wall edges that lie opposite one another. In this connection, the broad pipe side walls 13a; 13b of the pipe wall 10 of the endless flat pipe are expediently oriented vertically after bending.

Furthermore, the second flat strip material 58 is bent in such a manner that the endless turbulence insert 57 is enclosed or sheathed by the pipe wall 10 formed by the second endless flat strip material 58, and the endless turbulence insert 57 is disposed between the two broad pipe side walls 13a; 13b. Furthermore, the contact surfaces or outer surfaces 41; 47; 50; 53 lie against the inner pipe surface 12 in the region of the two broad side walls 13a; 13b. Furthermore, the endless turbulence insert 57 preferably extends over the entire width and over the entire length of the flat pipe 4.

As has already been explained above, the bending devices serve for bending, particularly by means of roll forming, the second endless flat strip material 58 to produce the longitudinally slit endless flat pipe that has just been described. In this connection, it is practical if two different types of forming or bending devices are present. The first bending devices have a lower and an upper forming or bending roller, in each instance, which rollers are disposed above and below the second flat strip material 58, in each instance, whereby the axes of rotation of the bending rollers are horizontal and perpendicular to the transport direction 62. The bending rollers have mantle surfaces, in each instance, in known manner, the shape of which surfaces is adapted to the shape of the flat pipe 4 to be produced. In particular, the mantle surfaces of the upper bending rollers have a convex curvature, and the mantle surfaces of the lower bending rollers have a concave curvature. The upper and lower bending rollers have a positive/negative shape with reference to one another. Furthermore, the upper bending rollers, disposed on the side of the endless turbulence insert 57, have a circumferential slit that extends radially into the bending roller, in each instance. The slit is dimensioned in such a manner that it accommodates the endless turbulence insert 57 during bending. As a result, the endless turbulence insert 57 is guided and stabilized in the slit.

The second flat strip material 58 passed through between the two bending rollers is successively bent or angled away around the upper bending roller, during rolling, because of the negative/positive shape of the bending rollers.

The second flat strip material 58 is bent by means of the first bending devices, as long as an upper bending roller still has room between the longitudinal strip edges 64 of the second endless flat strip material 58, in other words the pipe wall 10 is not yet completely closed.

Subsequently, the second flat strip material 58 is bent and formed further, by means of the second bending devices, until it has the desired cross-sectional shape. The second bending devices therefore follow the first bending devices in the transport direction 62. In the case of the second bending devices, the upper bending rollers no longer have a circumferential slit, since the upper bending rollers no longer engage between the longitudinal strip edges 64 of the second endless flat strip material 58, but rather merely serve as counter-pressure rollers.

After bending, the second flat strip material 58 that forms the pipe wall 10 and the endless turbulence insert 57 touch one another at multiple contact locations. As a result, the endless turbulence insert 57 is pulled along by the driven second flat strip material 58, with force fit and shape fit. Optionally, however, the device according to the invention can also have additional drive means for the endless turbulence insert 57. In particular, the device can have two friction rollers that lie horizontally opposite one another, in each instance, between the individual bending rollers. The friction rollers rotate about vertical axes of rotation and drive the endless turbulence insert 57. As a result, a synchronous speed of the second flat strip material 58 and the endless turbulence insert 57 is guaranteed.

The longitudinal strip edges 64 or now longitudinal pipe wall edges, which lie opposite one another, are continuously welded to one another, in known manner, in the welding device, which follows the last bending device in the transport direction 62, so that a closed, pre-finished endless flat pipe is formed. During welding, the two longitudinal strip edges 64 are pressed against one another by means of pressure rollers that engage on the two broad pipe side walls 13a; 13b, and the material is heated in the region of the longitudinal strip edges 64, in such a manner that it welds together, forming the longitudinal weld seam 20. It is practical if welding takes place by means of induction welding.

Alternatively to welding, the flat pipe 4 can also be longitudinally connected, in the region of the two longitudinal pipe wall edges, by means of a known folding connection or otherwise. Consequently, a different type of connection device, for example a soldering device or a gluing device, can also be provided, in place of the welding device.

A calibration device that brings about the production of the final outer contour as well as assuring the straightness of the endless flat pipe in the longitudinal pipe direction 18 preferably follows the welding device. The calibration device can furthermore have a scraping device for removing the weld seam excess and a cooling device for cooling the endless flat pipe.

It is practical if the cutting device of the device according to the invention has a blade (not shown) for cutting the endless flat pipe along a preferably vertical cutting line, so that the endless flat pipe is cut into individual flat pipes 4 having a desired pipe length. For cutting, the blade is pivoted or rotated about a horizontal axis, parallel to the transport direction 62, for example. In addition, the blade can be moved along in the transport direction 62 during the cutting process, in known manner (“flying blade”), in order to balance out the advancing movement of the endless flat pipe. According to a preferred embodiment of the invention, however, the blade is non-displaceable in the transport direction 62 (“standing blade”), whereby the movement of the endless flat pipe is balanced out by means of a shape of the blade that is slanted accordingly, in the transport direction 62, or by a correspondingly slanted position of the blade.

The cut flat pipes 4 are subsequently preferably also soldered in a soldering oven. For example, soldering can take place simultaneously with the soldering of the heat exchanger 1, which is equipped with the flat pipes 4 according to the invention. Because of the solder-plating of the first and second endless flat strip material 56; 58, preferably on both sides, the outer surfaces 41; 47; 50; 53 that lie against the inner pipe surface 12 are soldered to the inner pipe surface 12 when this happens. As a result, a firm bond between turbulence insert 21 and pipe wall 10 is produced.

It is advantageous, in the case of the production method according to the invention, by means of the device according to the invention, for one thing, that the flat pipe 4 according to the invention, including the turbulence insert 21, is produced continuously or online. As a result, the flat pipe 4 can be produced quickly and cost-advantageously. This is particularly made possible by means of the continuous plate-shaped strip region 32. This region makes it possible to bend the endless turbulence insert 57 around axes parallel to the strip width direction 25 when it is set onto the second flat strip material 58 laterally from above. This is not possible in the case of continuously corrugated metal sheets according to the state of the art.

Furthermore, it is advantageous that even very long pipes, which are only later cut into individual, shorter flat pipes 4 having the desired length, can be produced with the method according to the invention. This is not possible in the case of the multi-stage process according to the state of the art, since insertion of the turbulence inserts is no longer possible starting from a certain pipe length.

Furthermore, it is advantageous that the endless flat pipe does not have to be held open using additional means, for example blade rollers, before welding, but rather is automatically held open by the spring effect of the turbulence insert 21. The closed construction form furthermore prevents spangles (welding splashes) from distributing in the pipe.

Furthermore, the turbulence insert 21 can have punch-outs (not shown), preferably in the flat-surfaced strip regions 32. Punching of the first endless flat strip material 56 can take place in additional devices provided for this purpose, for example, which precede the combining device. Or punching can take place in the forming device.

1. Turbulence insert (21) for flat pipes (4) for heat exchangers (1), wherein
a) the turbulence insert (21) is a single-layer sheet-metal strip (22) that has a sheet center plane (26) as well as a longitudinal strip direction (24) and a strip width direction (25) perpendicular to it, and
b) wherein the turbulence insert (21) has first and second projections (30; 31), which are formed into the sheet-metal strip (22), wherein the first projections (30) are disposed on a first side of the strip center plane (26) and the second projections (31) are disposed on a second side of the strip center plane (26), which lies opposite the first side, wherein
c) the first and second projections (30; 31) are disposed one behind the other and alternating, in each instance, in the longitudinal strip direction (24), in the form of a longitudinal row (35), wherein the turbulence insert (21) has at least two longitudinal rows (35) disposed adjacent to one another in the strip width direction (25).

2. Turbulence insert (21) according to claim 1, wherein
a first projection (30) of the one longitudinal row (35), viewed in the strip width direction (25), lies adjacent to a second projection (31) of the adjacent longitudinal row (25) (35).

3. Turbulence insert (21) according to claim 1, wherein
the sheet-metal strip (22) has a flat-surfaced or plate-shaped, continuous strip region (32) that is interspersed or interrupted by the first and second projections (30; 31).

4. Turbulence insert (21) according to claim 3, wherein
the first and second projections (30; 31) project beyond the plate-shaped strip region (32), viewed in a strip thickness direction (27) perpendicular to the sheet center plane (26), wherein the first projections (30) project beyond the plate-shaped strip region (32) in a first direction (33), parallel to the strip thickness direction (27), and the second projections (31) project beyond the plate-shaped strip region (32) in a second direction (34), opposite the first direction (33).

5. Turbulence insert (21) according to claim 1, wherein
the projections (30; 31) are bowl-type or pot-shaped projections (36) and/or longitudinal beads (52) and/or transverse beads (53).

6. Turbulence insert (21) according to claim 1, wherein
the projections (30; 31; 36; 52; 53) have a wall (38; 44), in each instance, which is formed by a sheet wall (66) of the sheet-metal strip (22), wherein the walls (38; 44) are preferably closed, in each instance.

7. Flat pipe (4) for heat exchangers (1) having
a) a pipe wall (10) that has two broad pipe side walls (13a; 13b) that lie opposite one another, and two narrow pipe side walls (14a; 14b) that lie opposite one another, by way of which the broad pipe side walls (13a; 13b) make a transition into one another, and
b) a turbulence insert (21) disposed within the pipe wall (10), which is particularly disposed centered between the two broad pipe side walls (13a; 13b),
c) wherein the turbulence insert (21) is a single-layer sheet-metal strip (22) that has a sheet center plane (26) as well as a longitudinal strip direction (24) and a strip width direction (25) parallel to the latter,
d) wherein the turbulence insert (21) has first and second projections (30; 31), which are formed into the sheet-metal strip (22), wherein the first projections (30) are disposed on a first side of the strip center plane (26) and the second projections (31) are disposed on a second side of the strip center plane (26), which lies opposite the first side, and wherein the first projections (30) support themselves on the first broad pipe side wall (13a) and the second projections (31) support themselves on the second broad pipe side wall (13b), wherein
the turbulence insert (21) has the characteristics of claim 1.

8. Flat pipe (4) according to claim 7, wherein
the sheet-metal strip (22) has two longitudinal strip edges (23), wherein the one longitudinal strip edge (23) supports itself on the first narrow pipe side wall (14a) and the other longitudinal strip edge (23) supports itself on the second narrow pipe side wall (14b).

9. Flat pipe (4) according to claim 7, wherein
the projections (30; 31) are soldered to the inner pipe surface (12).

10. Flat pipe (4) according to claim 7, wherein
the projections (30; 31) are disposed in such a manner that a medium that flows through the flat pipe (4) flows through the flat pipe (4) in meander shape.

11. Flat pipe (4) according to claim 7, wherein
the pipe wall (10) is produced by means of roll forming and is welded by means of a longitudinal seam (20), preferably on the longitudinal side.

12. Heat exchanger (1), comprising
flat pipes (4) according to claim 7.

13. Method for continuous production of flat pipes (4) according to claim 7, having the following method steps:
a) making available a first metallic endless flat strip material (56), particularly by means of continuously discharging the first metallic endless flat strip material (56) from a first supply device,
b) forming the first endless flat strip material (56), particularly by means of two rolling rollers (61a, 61b) that can be rotated in opposite directions of rotation, between which rollers the first endless flat strip material (56) is passed through in a transport direction (62), to form a profiled endless turbulence insert (57) having the first and second projections (30; 31) and two lateral longitudinal strip edges (23),
c) making available a second endless flat strip material (58) having two lateral longitudinal strip edges (64) and two broad strip sides (65a; 65b), particularly by means of continuously discharging the second endless flat strip material (58) from a second supply device,
d) bringing together the endless turbulence insert (57) and the second endless flat strip material (58), in such a manner that the endless turbulence insert (57) lies against one of the two broad strip sides (65a) with one of its longitudinal strip edges (23),
e) continuously bending the second endless flat strip material (58), preferably by means of roll forming, to form an endless flat pipe having a longitudinally slit pipe wall (10) having two longitudinal pipe wall edges that lie opposite one another and having the two broad pipe side walls (13a; 13b), so that the pipe wall (10) encloses the endless turbulence insert (57), and the endless turbulence insert (57) is disposed between the two broad pipe side walls (13a; 13b),
f) connecting, particularly welding, the two longitudinal pipe wall edges,
g) cutting the endless flat pipe into individual flat pipes (4).

14. Device for continuous production of flat pipes (4) produced according to the method according to claim 13, which has
a) a turbulence insert pre-finishing device having a forming device (60) having means for forming a first metallic endless flat strip material (56) to form a profiled endless turbulence insert (57) having the first and second projections (30; 31) and two lateral longitudinal strip edges (23),
b) means for making available a second endless flat strip material (58) having two lateral longitudinal strip edges (64) and two broad strip sides (65a; 65b),
c) a combining device having means for bringing together the endless turbulence insert (57) and the second endless flat strip material (58), in such a manner that the endless turbulence insert (57) lies against one of the two broad strip sides (65a) with one of its longitudinal strip edges (23),
d) multiple bending devices, disposed one behind the other with reference to a transport direction 62, for continuously bending the second endless flat strip material (58), preferably by means of roll forming, to form an endless flat pipe having a longitudinally slit pipe wall (10) having two longitudinal pipe wall edges that lie opposite one another and having the two broad pipe side walls (13a; 13b), so that the pipe wall (10) encloses the endless turbulence insert (57), and the endless turbulence insert (57) is disposed between the two broad pipe side walls (13a; 13b),
e) a connecting device, particularly a welding device, for connecting the two longitudinal pipe wall edges,
f) and a cutting device for cutting the endless flat pipe into individual flat pipes (4).

15. Device according to claim 14, wherein
first bending devices have two bending rollers that lie opposite one another, in each instance, wherein the one bending roller has a circumferential slit that extends radially into the bending roller, in each instance, and in which slit the endless turbulence insert (57) can be accommodated during bending.
